(19) United States
(12) Patent Application Publication
(10) Pub. No.: US 2007/0285325 A1
(43) Pub. Date: Dec. 13, 2007

(54) Chi energy amplifier

(76) Inventor: John Quincy St. Clair, San Juan, PR (US)

Correspondence Address: JOHN ST. CLAIR, 52 KINGS COURT, 4A, SAN JUAN, PR, 00911, US

(21) Appl. No.: 11/448,456

(22) Filed: Jun. 7, 2006

(51) Int. Cl. H01Q 1/00; H01Q 13/10

(52) U.S. Cl. 343/720; 343/767

(57) ABSTRACT

A Chi energy amplifier that utilizes a co-gravitational K field to generate a flow of hyperspace energy into or out of a ceramic dome containing a slot antenna.

### BRIEF SUMMARY OF THE INVENTION

This invention is an energy amplifier that controls the direction of the second co-gravitational K field by means of a slot antenna located in a resonating sphere. The hyperspace mass flow rate entering into this dimension is determined by the frequency of the antenna. This energy flow is used to increase the energy of the human energy field known as Chi.

### BACKGROUND OF THE INVENTION

Referring to FIG. 1, a pendulum suspended by a string (3) is held by the string with the right hand (1) over the upright palm of the left hand (2). The pendulum swings in circles shown by the clockwise direction of the arrow (4). The pendulum swings at a constant frequency at about 1 to 2 Hz. What this means is that there is a second gravitational K field (5) that can cause a mass to rotate in circles.

Everyone is familiar with the linear gravitational g field which is defined as Newton's gravitational constant G times the mass of the earth divided by the square of the radius of the earth. This is the field that causes objects to accelerate radially toward the earth's surface. Newton's gravitational constant G is equal to the speed of light c squared divided by the linear mass Ω of the universe. The speed of light is

$$\begin{matrix}\begin{matrix} c = 299792458 \frac{meters}{second} \\ Ω = 1.346812891 \cdot {10}^{27} \frac{kilograms}{meter}\end{matrix} \\ G = \frac{{c}^{2}}{Ω} = 6.673200002 \cdot {10}^{- 11} \frac{{meter}^{3}}{{second}^{2} kilogram}\end{matrix}$$

### The mass and radius of the earth are

$$\begin{matrix}\begin{matrix} ME = 5.977 \cdot {10}^{24} kilograms \\ RE = 6371.03 {10}^{3} meters \end{matrix} \\ g = G \frac{ME}{{RE}^{2}} = 9.82 \frac{meters}{{second}^{2}}\end{matrix}$$

From electromagnetism, the electric E field is linear and the B magnetic field is circular or forms closed loops. The electric field starts and ends on electric charges. Since there are two electromagnetic fields, it makes sense that there are also two gravitational fields. A flow of electric current through a straight wire causes a circular magnetic B field to form around the wire. In a similar manner, a flow of mass through a channel causes a circular gravitational K field to form around the channel.

Referring to FIG. 2, the right hand rule (6) shows that if the flow is along the direction of the thumb of the right hand, then the field curls around in the direction of the fingers. If an electric current is flowing through the wire (7) in the direction of arrow (8), then a counter-clockwise magnetic field circles the wire shown by arrow (9). In the bottom view, a mass flowing through a channel (10) in direction (11) generates a counter-clockwise gravitational K field shown by arrow (12). This field is the reason that the pendulum swings in circles. The gravitational K field only exists if there is a mass flow. In the wire there is also an electric field driving the electrons, so it must be that there is a g gravitational field driving the mass along the channel.

The correspondence between electromagnetic and gravitational constants must be the following:

| Electric | Gravitational |
|---|---|
| Charge q | Mass m |
| Electric Field E | Gravitational Field g |
| Magnetic Field B | Co-gravitational Field K |
| Linear Electric Charge λ | Linear Mass Ω |
| Permittivity of Space ε₀ | −1/4πG |
| Permeability of Space μ₀ | −4πG/c² |
| Convection Current Density J | Mass Current Density J |

Maxwell's equation for the curl or circulation of B involves the current density J and an electric field E changing with time t

$$∇ \times B = {μ}_{0} J + \frac{1}{{c}^{2}} \frac{\partial E}{\partial t}$$

### The corresponding gravitational equation is therefore

$$∇ \times K = - \frac{4 π G}{{c}^{2}} J + \frac{1}{{c}^{2}} \frac{\partial g}{\partial t}$$

If the g field is constant with time, then the circulation of the K field only depends on the mass density flow through the channel. Notice the minus sign in front of the first term which says that if energy is entering our dimension through a channel, then the K field is in the counterclockwise direction as indicated by the pendulum. As seen in FIG. 1, the energy is leaving through the left hand because the rotation is clockwise. On the right hand, the pendulum rotates in the counterclockwise direction indicating that energy is coming from the hand. Thus there is a flow of energy between the hands known as the Chi energy. The purpose of this invention is to amplify this energy.

The g gravitational field is due to a negative space-time curvature created by the mass of the earth. In many physics books this is depicted as a bowl. So the idea was to acquire a ceramic kiln which could produce ceramic bowls using earthenware clay and a bowl mold. The curvature created by the bowl, if any, could be detected by the pendulum.

Referring to FIG. 3, a pendulum (13) held in the right hand with the left hand near the side of the concave mold (14) starts to swing toward the right, away from the plaster mold as shown by arrow (15).

Referring to FIG. 4, a pendulum (16) held in the right hand over a positive curvature dome (17) swings toward the top of the dome as shown by arrow (18). Supposedly the K gravitational field rotates in circles, but these experiments showed that the pendulum movement was radial.

Referring to FIG. 5, the pendulum (19) swings radially (20) toward the top of the dome (23) because the forces (24) around the dome counteract each other as shown by arrows (21, 22). Thus there is no sideways pressure on the pendulum.

The next question was what is the value of the co-gravitational K constant? In electromagnetism the electric field is the speed of light times the magnetic field. So the g gravitational field should be the speed of light times the co-gravitational K field.

$$\begin{matrix}K = \frac{g}{c} \\ = \frac{1}{c} G \frac{MU}{{RU}^{2}} \\ = \frac{1}{c} \frac{{c}^{2}}{Ω} \frac{MU}{\frac{MU}{Ω} RU} \\ = \frac{c}{RU}\end{matrix}$$

$$ln ( K ) = - 40.34861143$$

where the radius RU of the universe is 10²⁶ meters and c is the speed of light. The speed of light divided by the radius is angular frequency measured in Hz. Recall that the pendulum over the hand has a frequency f of 1 Hz which makes the angular frequency o equal to 2π radians per second since ω=2πf So the question is whether or not this value of K means anything in terms of hyperspace physics?

The universe has a geometrical sub-manifold based on the tetrahedron. All the physics constants of the universe are determined by this tetrahedral geometry. As shown in diagram tet0565 stored in the Library of Congress, the electron and proton are one and the same particle. There is a continuous clockwise path from the electron wavelength, through electric charge to electron mass and returning out-of-dimension back along a counterclockwise path as the proton. Because the paths are in opposite directions, the proton has a positive charge and the electron has the opposite negative charge. Because this path crosses into our dimension from hyperspace, we see two different particles. Thus Nature only has one particle. The tetrahedron diagram also shows that our dimension is offset from the origin of the diagram by the Cabibbo angle which is found in particle physics. Our dimension is determined by the Planck mass and the Planck wavelength which are the bottom limits of our dimension, known as the Planck box. If the proton mass is centered on the Planck mass, a tangent line to the circle can only be made by using the down quark and up quark which comprise the proton (duu). And the tangent line is drawn at the Cabibbo angle. So the diagram verifies some important experimental physics data.

Referring to FIG. 6, the tetrahedron diagram is drawn with a vertical axis (35) corresponding to the natural logarithm of mass. The horizontal axis (36) is the natural logarithm of wavelength. The inverted tetrahedrons (25, 26) cross at the centerline (28) which is known through remote viewing as “the merging of two worlds.” The centerline is the separation point between space and hyperspace. The circumscribing sphere (27) has a horizontal diameter (29) and a vertical diameter (30). The electron wavelength (34) reflects off the sphere and returns as the electron mass (33).

Because the K co-gravitational field is related to circular or spinning motion, as well as vorticity per area, it might be imagined that it has something to do with the spinning electron. The energy E of the electron is equal to the mass mₑ of the electron times the speed of light c squared.

$$\begin{matrix}\begin{matrix}\begin{matrix} {m}_{e} = 9.1093897 \cdot {10}^{- 31} kilogram \\ c = 299792458 \cdot \frac{meter}{second} \end{matrix} \\ E = {m}_{e} {c}^{2} \end{matrix} \\ ln ( E ) = - 30.13363019\end{matrix}$$

The tips of the inverted tetrahedrons pass through the base constant, vertical line (37), which is equal to Planck's constant h divided by the speed of light.

$$\begin{matrix} h = 2.210260685 \cdot {10}^{- 42} kilogram meter \\ base = ln ( \frac{h}{c} ) = - 95.91546344\end{matrix}$$

On the tetrahedron diagram, the co-gravitational circle K (31) is centered on the base (37) at the electron energy (32) shown by the small π circle at the intersection (38). As can be seen, the K circle determines the electron mass (33) at the horizontal axis (36) as shown by intersection (39). Because the electron is the proton, it also sets the constants of the proton such as wavelength, charge and mass. Thus the K co-gravitational field determines our elementary particles. Because these particle paths go in and out of dimension, it means that hyperspace exists. And because the K field is circular, depending on the direction of the energy flow, another purpose of this invention is to control the direction of the field.

### SUMMARY OF THE INVENTION

Referring to FIG. 7, the Chi energy amplifier consists of two ceramic domes (40, 41) resting one on the other such as to form a hollow internal clam-like structure. The domes are mounted on a cylindrical ceramic base (42) containing a reinforced passageway for the coaxial cable and BNC connector (43). The BNC connector plugs into the frequency generator (not shown) which has a frequency range of 0.4 Hz to 5 MHz.

Referring to FIG. 8 with the upper dome removed, the coaxial cable (44) extends vertically through the base into the lower dome. The cable is soldered to a slot antenna (45). The center conductor of the cable is soldered to the left side of the slot and the ground shielding is soldered to the right side of the slot. Thus there is a voltage difference on the two sides which produces an oscillating electric field across the slot which radiates electromagnetic energy into the hollow dome.

A close-up of the slot antenna is shown in FIG. 9. The antenna is a 0.050″ thick copper sheet (46) with a width of ¾ wavelength by a height of ½ wavelength. A slot (47) of ½ wavelength is electric-discharge machined into the copper sheet (47). The center conductor (48) from the coaxial cable is soldered to the top of the slot. The ground wire (49) is soldered to the bottom of the slot. This configuration produces a voltage difference between the inner top and bottom surfaces of the slot. The frequency generator produces an oscillating voltage across the slot which generates an electric field that radiates from the antenna into the ceramic cavity.

The wavelength of the antenna and the dimensions of the ceramic cavity have to be tuned to the geometry of our dimension. Newton's gravitational constant G is equal to

$$\begin{matrix}\begin{matrix}\begin{matrix}\begin{matrix} ln ( G ) = - 23.4303342 \\ f = {e}^{23.4303432} * Hz = 15 Ghz \end{matrix} \\ λ = \frac{c}{f} = .020 meter = .787 inch\end{matrix} \\ slotwidth = \frac{λ}{2} = .393 inch \end{matrix} \\ antennawidth = \frac{3}{4} λ = .590 inch\end{matrix}$$

The frequency of the antenna is the inverse of the gravitational constant. The reason for this is that when a circle of radius natural logarithm G is centered on the proton on the tetrahedron diagram, the circle intersects the corner of the Planck box which bounds our dimension between space and hyperspace. It is the low-density hyperspace energy that the amplifier will bring into this dimension.

The size of the ceramic cavity based on the angular frequency ω=2πf is

$$\frac{\frac{{ω}^{2}}{{c}^{2}} + \frac{1}{ab}}{\frac{{ω}^{2}}{{c}^{2}} + ab ( \frac{{ω}^{2}}{{c}^{2}} - \frac{1}{{a}^{2}} ) ( \frac{{ω}^{2}}{{c}^{2}} - \frac{1}{{b}^{2}} )} = \frac{tan ( \frac{ω}{c} ( b - a ) )}{ω} \frac{ c}{b - a}$$

where b is inside radius of the cavity, a is the radius of an object at the center of the cavity and c is the speed of light. Using the object radius as a=0.020 meter to account for the antenna, the inside radius of the cavity is b=4.25 inches which is the size of the 8.5 inch diameter ceramic dome using ¼ inch thick clay. The frequency is then equal to

$$f = ln ( \frac{ω}{2 π} ) = 23.45$$

which is close to the inverse of the gravitational constant G of −23.43. Thus the amplifier is tuned to the gravitational constant of the universe both in size of the cavity and the frequency of the slot antenna. Using a SMD surface mount capacitor and inductor in the picofarad and nanohenry range, it is possible to get up to this high frequency, but it was found that it was not necessary because the amplifier works at lower frequencies that are pulsed.

Referring to FIG. 10, the swinging movement of the pendulum measured in inches at the side of the dome is plotted against a range of frequencies from 20 kHz to 120 kHz. At 20 kHz, the pendulum swings ¾ inch away from the dome. Then at 40 kHz, the pendulum swings ¾ inch toward the dome. This pattern is repeated until 120 kHz. What this means is that the amplifier can control the direction of the co-gravitational field using frequency. The tetrahedron diagram shows that this phenomenon is related to the two axes of the circumscribing sphere of the tetrahedron.

Referring to FIG. 11, the swinging of the pendulum is plotted for a range of frequencies from 1 MHz to 5 MHz. At a frequency of 2.78 MHz the pendulum was swinging strongly from the vertical to the horizontal, a distance of six inches. On the tetrahedron diagram, the distance from our base constant to the centerline between inverted tetrahedrons is equal to 14.838168. This corresponds to a frequency of

f=e^{14.838168}*Hz=2.780574169 MHz

which is close to the experimental value.

Referring to FIG. 12, the Chi energy flowing between the hands, shown by the arrows, is amplified by placing the hands across the dome. This energy from the right hand mixes with the hyperspace energy entering the dome from hyperspace. The combined energy is then absorbed in the left hand vortex. The effects of this amplified energy are simply amazing and have to be experienced to appreciate what it means.

### A BRIEF DESCRIPTION OF THE DRAWINGS

FIG. 1. Perspective view of pendulum movement over left hand vortex.

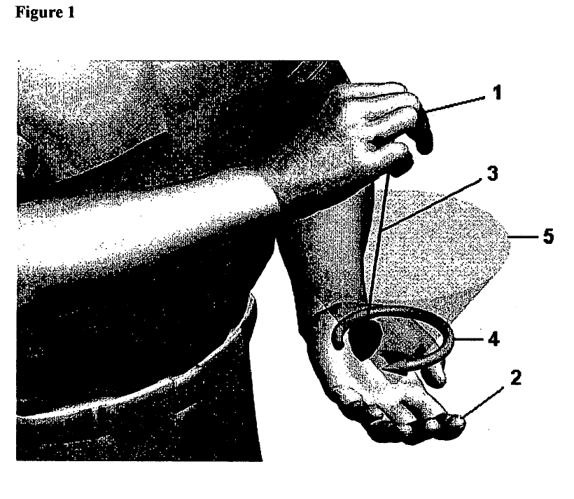

FIG. 2. Perspective view of right hand rule of physics showing similarity between electromagnetism and gravity.

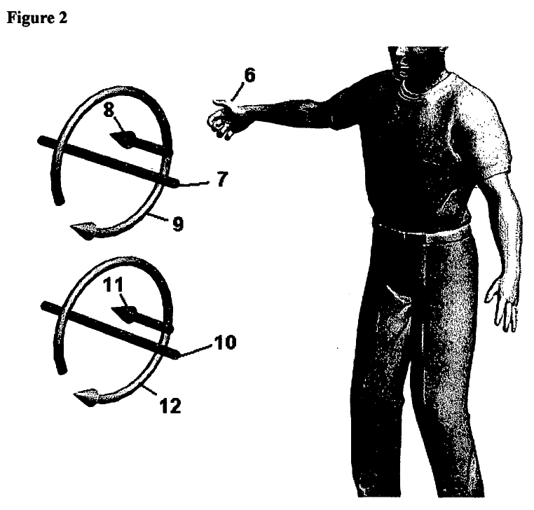

FIG. 3. Perspective view of plaster mold cavity showing negative curvature.

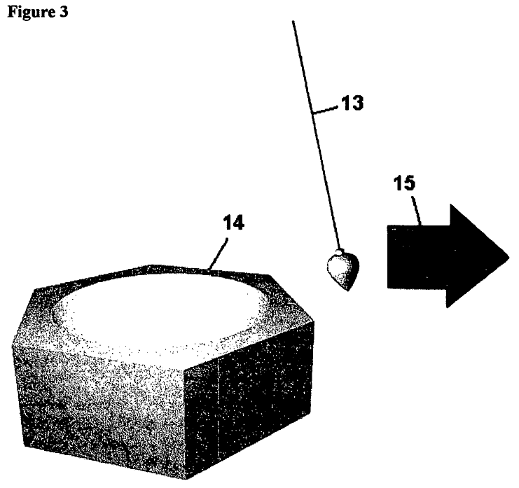

FIG. 4. Perspective view of dome showing positive curvature.

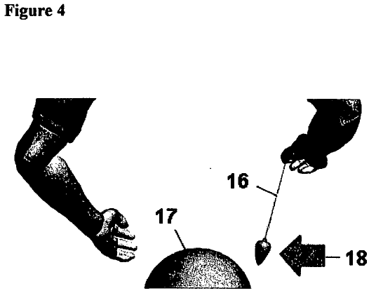

FIG. 5. Perspective view of dome showing radial pendulum movement.

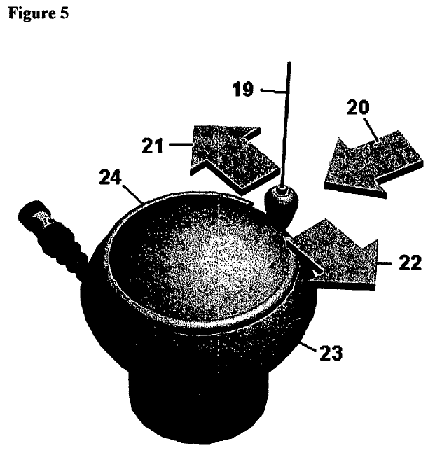

FIG. 6. Graph of co-gravitational K field on tetrahedron diagram.

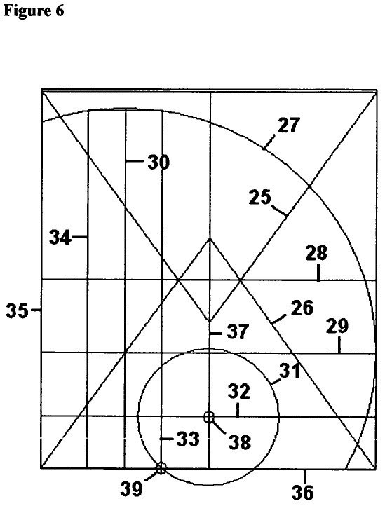

FIG. 7. Perspective view of Chi Energy Amplifier with BNC coaxial cable.

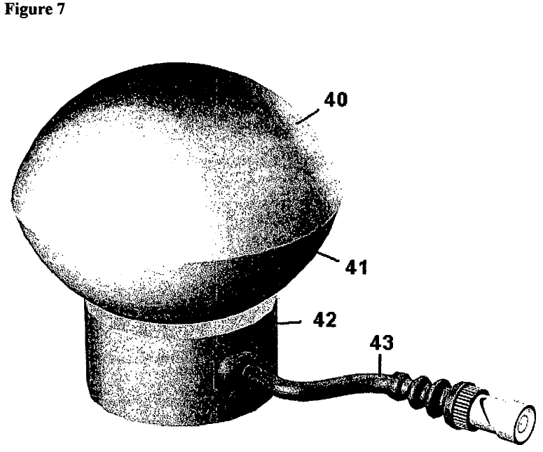

FIG. 8. Perspective view of slot antenna in dome.

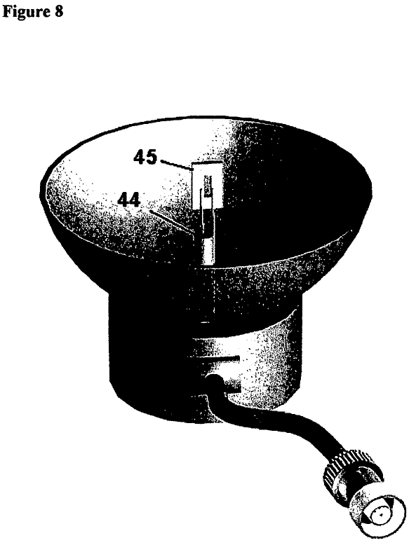

FIG. 9. Perspective view of slot antenna showing dimensions.

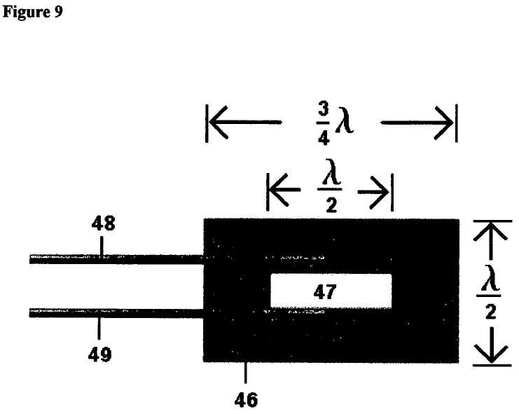

FIG. 10. Graph of pendulum movement versus frequency of antenna, 20 KHz.

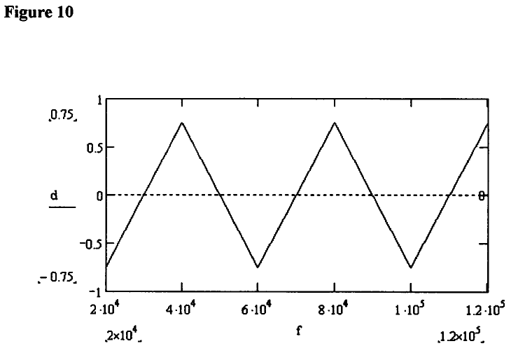

FIG. 11. Graph of pendulum movement versus frequency from 1 MHz to 5 MHz.

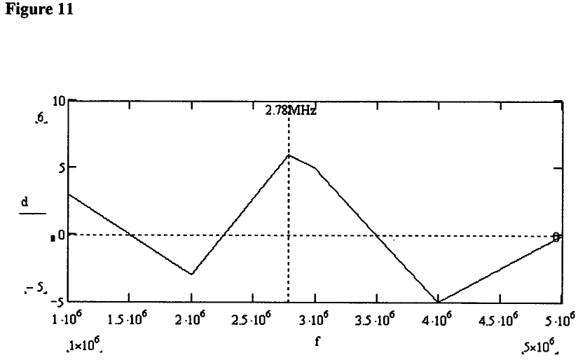

FIG. 12. Perspective view of amplifying Chi energy.

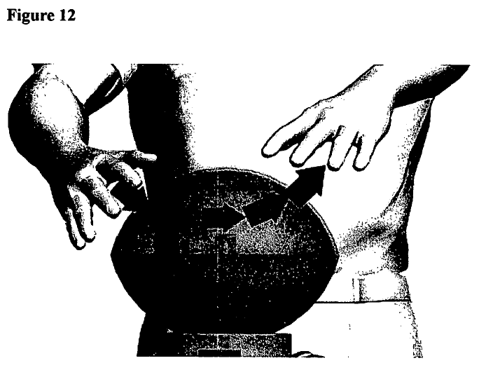

### DETAILED DESCRIPTION OF THE INVENTION

The dome of the amplifier is made of red earthenware clay from Minnesota having a cone 06 kiln firing temperature of 1828° F. over a period of 7.5 hours. The clay is placed between two hardwood ¼ inch thick slats. It is then rolled flat with a rolling pin. The sheet of clay is cut in half and one half is placed in a 9-inch diameter bowl mold using a soft sponge to push it into position. The second half is then added to the first with the seam between worked flat with a metal kidney and elephant ear sponge. The top of the mold is scrapped flat to create the bowl shape. The moist clay is left to dry for one day after which it falls out of the mold due to shrinkage. After completely drying, the dome is then placed in a kiln which runs the computer-controlled cone 06 temperature firing profile. A preheat at 180° F. for one hour is required to make sure the dome is completely bone dry. It takes 7 to 8 hours to fire the dome with another 12 hours to cool down naturally.

The base is also made of ¼ inch clay. A circular shape is cut out and fitted with a ribbon of extruded clay from a clay gun to make the cylindrical wall. Using a hole cutter made of hollow tubing, a hole is made in the side of the base for the coaxial cable. The second lower dome has a hole cut in the bottom when the clay is leather hard.

A 0.050″ thick copper sheet is EDM machined to cut a half wavelength slot in the copper. The inner conductor of the coaxial cable is soldered using silver epoxy to the one side of the slot. The ground shielding of the cable is silver epoxied to the other side of the slot. The other end of the coaxial cable has a BNC connector which plugs into the frequency generator.

The pendulum is made out of soft brass rod and machined on a lathe into a plumb bob shape. A hole is drilled in the stem to hold the 6″ long string.

I claim:

1. A Chi energy amplifier comprising:
a. a hollow ceramic dome in the shape of a clam shell with a hole in the lower half that provides access to a coaxial cable;
b. a cylindrical ceramic base on which the dome is mounted with holes that provide access for a coaxial cable into item (a);
c. a slot antenna soldered to the coaxial cable, located midway inside item (a), such that the inner conductor of the cable is soldered to one side of the slot and the ground shielding is soldered to the other side of the slot;
d. a frequency generator connected to the other end of the coaxial cable by means of a BNC connector for the purpose of providing an oscillating voltage to item (c);
e. an electromagnetic wave generated by items (c, d) that resonates inside item (a);
f. a co-gravitational K field generated by items (a, b, c, d, e) whose direction can be controlled by the frequency of item (d); and
g. a flow of hyperspace energy into or out of the dome due to item (f).
